(19) United States
(12) Patent Application Publication
(10) Pub. No.: US 2008/0245803 A1
(43) Pub. Date: Oct. 9, 2008

(54) Portable Cooling System and Associated Method

(76) Inventor: Ignatios Angelidis, Clermont, FL (US)

Correspondence Address: Terry M. Sanks;Beusse Wolter Sanks Mora & Maire, P.A., Suite 2500, 390 North Orange Avenue, Orlando, FL, 32801, US

(21) Appl. No.: 11/696,424

(22) Filed: Apr. 4, 2007

(51) Int. Cl. A47J 41/00

(52) U.S. Cl. 220/592.17

(57) ABSTRACT

A portable cooling system is provided including a beverage container holding a cooled beverage or a digestable cooling element, and an air duct including an inlet and an outlet. During operation of the personal cooling system, an inner surface of the air duct contacts an outer surface of the beverage container. More particularly, a powered fan is coupled to the air duct, to draw outside air with an initial temperature into the inlet. Additionally, the powered fan is coupled to the air duct to pass the outside air through the air duct to thermally engage the outer surface of the beverage container, and to push the outside air through the outlet with a reduced temperature from said initial temperature.

### FIELD OF THE INVENTION

The present invention relates to cooling systems, and more particularly, to a portable cooling system and associated method.

### BACKGROUND OF THE INVENTION

In areas of high outdoor temperatures, there has been an ever-present demand for effective cooling systems which provide a steady stream of cool air over the individual. Historically, manual cooling systems, such as manual fans, are inefficient because they require human work input, thereby increasing the individual's temperature, and thus defeating the purpose of the cooling system. Although some automatic cooling systems have been developed, each automatic cooling system has distinct shortcomings. For example, automatic powered fan systems have been developed, but many automatic powered fan systems are not portable and thus an individual may not use these systems to travel in a high outdoor temperature area, such as during a long walk, for example. Although some portable automatic powered fan systems have been developed, these systems also have distinct shortcomings. For example, several portable automatic powered fan systems include a powered fan spraying a mist supplied from a water container. Thus, such a portable automatic powered fan system will cease to operate after the supply of water runs out. Additionally, several portable automatic powered fan systems include a powered fan circulating surrounding outside hot air over the individual, and thus failing to provide any meaningful relief from the high outdoor temperature.

Accordingly, it would be advantageous to provide a portable cooling system to be carried with the individual and which provides meaningful relief from the high outdoor temperature.

### BRIEF DESCRIPTION OF THE INVENTION

In one embodiment of the present invention, a portable cooling system is provided, including a beverage container holding a cooled beverage or a digestable cooling element, and an air duct including an inlet and an outlet. More particularly, an inner surface of at least a portion of the air duct contacts an outer surface of the beverage container. Additionally, the portable cooling system includes at least one powered fan coupled to the air duct, to draw outside air with an initial temperature into the inlet, pass the outside air through the air duct to thermally engage the outer surface of the beverage container, and push the outside air through the outlet with a reduced temperature from the initial temperature.

In one embodiment of the present invention, a method is provided for portably cooling an individual, including providing a beverage container holding a cooled beverage or a digestable cooling element, and contacting an outer surface of the beverage container with an inner surface of at least a portion of an air duct, where the air duct includes an inlet and an outlet. More particularly, the method includes coupling at least one powered fan to the air duct, drawing outside air with an initial temperature into the inlet, and thermally engaging the outside air with the outer surface of the beverage container as the outside air is passed through the air duct. Additionally, the method further includes pushing the outside air through the outlet with a reduced temperature from the initial temperature.

### BRIEF DESCRIPTION OF THE DRAWINGS

A more particular description of the embodiments of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is perspective view of an embodiment of a portable cooling system according to the present invention.

FIG. 2 is a cross-sectional view of an embodiment of an air duct for a portable cooling system according to the present invention.

FIG. 3 is a cross-sectional view of an embodiment of an air duct for a portable cooling system according to the present invention.

FIG. 4 is a partial perspective view of an embodiment of a portable cooling system according to the present invention.

FIG. 5 is a flow chart illustrating an exemplary method embodiment of the system illustrated in FIG. 1.

### DETAILED DESCRIPTION OF THE INVENTION

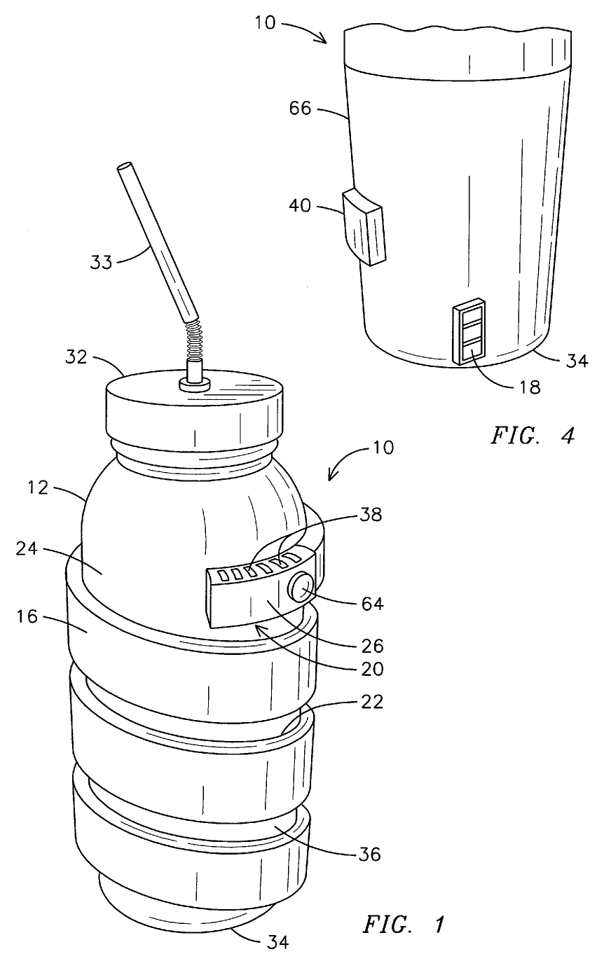

FIG. 1 illustrates a portable cooling system 10 for individual use. The portable cooling system 10 may be used in various applications, such as during outdoor activity such as walking in areas of high outdoor temperatures, for example. However, the portable cooling system 10 may be used in any scenario to accomplish personal cooling while still providing the flexibility of a portable system.

As shown in FIG. 1, the portable cooling system 10 illustratively includes a beverage container 12 holding a cooled beverage or a digestable cooling element, such as ice, for example, where the beverage container includes a removable top 32 to cover a top opening (not shown). Additionally, the beverage container 12 in the exemplary embodiment of FIG. 1 includes a base 34, a side portion 36, and a straw 33 passing through the removable top 32. Although the exemplary embodiment of FIG. 1 includes a beverage container holding a cooled beverage or a digestable cooling element such as ice (i.e., without liquid), the beverage container may additionally hold a cooled beverage with or without ice. Additionally, although the exemplary embodiment of the beverage container 12 illustrated in FIG. 1 includes a cylindrical-shaped side portion 36, and a straw 33 passing through the removable top 32, the beverage container of the portable cooling system is not limited to this beverage container configuration or any single beverage container configuration, and includes any beverage container configuration or shape with an outer surface capable of thermally engaging the air duct, as discussed below.

As further illustrated in the exemplary embodiment of FIGS. 1 and 4, the portable cooling system 10 includes an air duct 16 having an inlet 18 positioned at one end of the air duct for accepting an inflow of outside air. Additionally, the air duct 16 includes an outlet 20 positioned at an opposite end from the inlet for passing out an outflow of outside air originally accepted into the inlet, as discussed in further detail below. As illustrated in FIG. 1, the air duct 16 is positioned along the outer surface 24 of the beverage container 12 such that an inner surface 22 of the air duct 16 contacts an outer surface 24 of the beverage container 12. As illustrated in FIG. 1, the air duct 16 includes a linear air duct arranged to contact the outer surface 24 in a spiral arrangement such that the outside air flows in one direction relative to the beverage container 12. Although FIG. 1 illustrates a substantial portion of the inner surface of the air duct in contact with the outer surface of the beverage container, the portable cooling system may include any portion of the inner surface of the air duct in contact with the outer surface of the beverage container.

As further illustrated in the exemplary embodiment of FIGS. 1 and 4, a powered fan 26 is coupled to the air duct 16 adjacent to the outlet 20 such as within the air duct adjacent to the outlet, for example. However, the powered fan may be positioned external to the air duct and adjacent to the outlet. The outlet 20 contacts the outer surface 24 of the side portion 36 of the beverage container 12 adjacent to the removable top 32 at the top opening. The inlet 18 contacts the outer surface 24 of the side portion 36 of the beverage container 12 adjacent to the base 34 of the beverage container.

By coupling the powered fan 26 to the air duct adjacent to the outlet 26, the powered fan draws outside air with an initial temperature into the inlet 18, as appreciated by one of skill in the art. Upon being drawn into the inlet 18, the powered fan 26 passes the outside air through the air duct 16 to thermally engage the outer surface 24 of the beverage container 12. By thermally engaging the outer surface 24 of the beverage container 12, the outside air within the air duct 16 initiates a heat exchange process with the cooled beverage within the beverage container. Upon passing through the air duct 16 and thermally engaging the beverage container 12, the powered fan 26 pushes the outside air through the outlet 20 with a reduced temperature from the initial temperature upon entering the inlet 18. In the exemplary embodiment of FIG. 1, the powered fan 26 is positioned within the air duct 26 and adjacent to the outlet 20 to push the outside air through a plurality of slits 38 in the air duct 16 adjacent to the outlet. The decrease in the outside air temperature from the initial temperature to the reduced temperature is attributable to thermally engaging the beverage container 12 and the heat exchange process with the cooled beverage within the beverage container. In an exemplary embodiment of the portable cooling system, the reduced temperature is at least fifteen degrees less than the initial temperature. However, the portable cooling system is not limited to any specific difference between the initial temperature and reduced temperature. Although FIG. 1 illustrates a single powered fan, the portable cooling system may include more than one powered fan coupled to each air duct outlet. Additionally, although FIG. 1 illustrates the powered fan coupled to the air duct adjacent to the outlet, the powered fan may be coupled at any location along the air duct or external to the air duct, including adjacent to the inlet. Although FIG. 1 illustrates a plurality of slits adjacent to the outlet for pushing outside air through the outlet, one slit may be utilized.

The powered fan 26 is powered by at least one portable power source 40 coupled to the outer surface 24 of the beverage container, as illustrated in FIG. 4. Additionally, the exemplary embodiment of FIG. 1 illustrates a switch 64 coupled to the portable power source 40 to selectively turn the portable cooling system 10 on and off. The portable power source may be coupled at any location along the outer surface of the beverage container, and is electrically connected to the powered fan, as appreciated by one of skill in the art. Although the switch illustrated in FIG. 4 is an electrical switch to the portable power source, the portable cooling system may include a mechanical or manual switch.

As illustrated in the exemplary embodiment of FIG. 4, the inlet 18 is positioned adjacent to the base 34 of the beverage container 12 and is utilized to drain condensation collected in the air duct during operation of the portable cooling system 10.

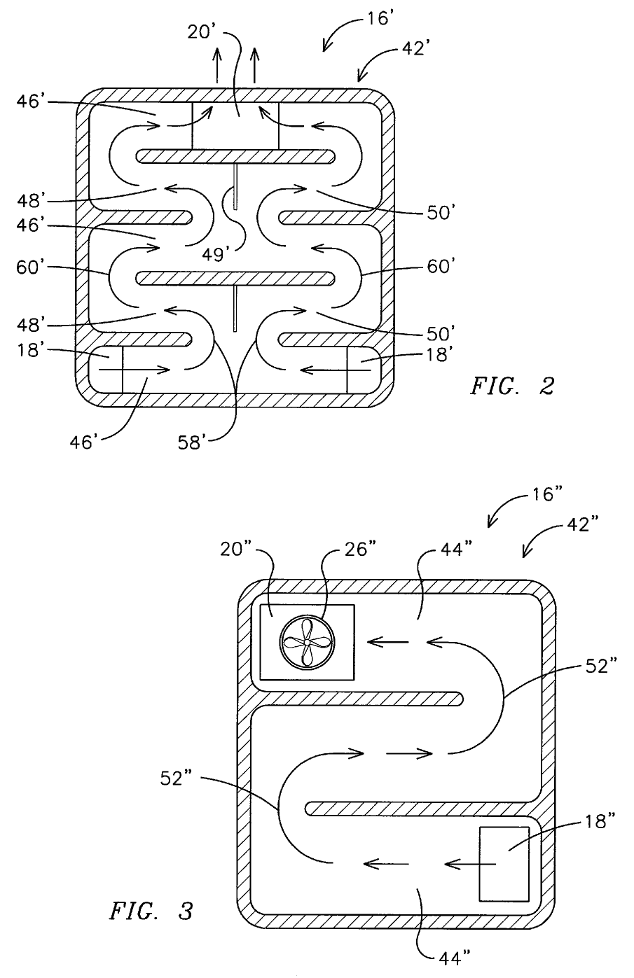

As illustrated in the exemplary embodiments of FIGS. 2 and 3, which illustrate exemplary embodiments of air ducts 16′ (FIG. 2), 16″ (FIG. 3) for contacting the outer surface of the beverage container. Each air duct 16′,16″ illustratively includes respective exemplary embodiments of a serpentine network 42′ (FIG. 2), 42″ (FIG. 3) between the respective inlets 18′,18″ and outlets 20′,20″ of the air ducts 16′,16″ to contact the respective outer surface of the beverage container.

In the exemplary embodiment of the serpentine network 42′ illustrated in FIG. 2, a plurality of channels 46′, 48′,50′ include a plurality of first channels 46′ extending a substantial portion of the circumference of the outer surface of the beverage container. More particularly, the plurality of channels includes a plurality of pairs of second channels 48′,50′, where each pair of second channels collectively extends a substantial portion of the circumference of the outer surface of the beverage container, with a partition 49′ between each respective pair of second channels. Each first channel 46′ and pair of second channels 48′,50′ are adjacently positioned from the inlet 18′ to the outlet 20′. Additionally, the serpentine network 42′ includes a plurality of turns 58′,60′ including a plurality of first turns 58′ including two diverging turns within each first channel 46′ to pass converging outside air within each first channel to diverging outside air in an adjacent respective pair of second channels 48′,50′ separated by a partition 49′. The plurality of turns further include a plurality of second turns 60′ including two converging turns within each respective second channel 48′,50′ to pass the diverging outside air in respective second channels to converging outside air within an adjacent first channel 46′. The inlet 18′ illustratively passes the converging outside air into a first 46′ of the plurality of the first channels adjacent to the base of the beverage container. Additionally, the outlet 20′ passes the converging outside air from a last 46′ of the plurality of the first channels adjacent to the removable top of the beverage container. Although FIG. 2 illustrates an embodiment of a serpentine network 42′ including three first channels, three pairs of second channels, and two respective pairs of converging and diverging turns, the serpentine network may include any number of first channels, pairs of second channels and corresponding pairs of converging and diverging turns. Those other elements, not discussed in the embodiment of the serpentine network 42′, are indicated with prime notation, similar to those elements discussed the above embodiments, and require no further discussion herein. In an exemplary embodiment of the serpentine network 42′, the air duct may include dimensions of 1″×½″×50″ in length, and the beverage container may be at least 32 oz in volume.

In the exemplary embodiment of the serpentine network 42″ illustrated in FIG. 3, a plurality of channels 44″ each extend a substantial portion of the circumference of the outer surface of the beverage container. Additionally, the serpentine network 42″ illustratively includes a plurality of turns 52″ including a respective turn 52″ for passing the outside air between adjacent channels 44″ of the plurality of channels and cause the outside air to pass in opposing directions in the adjacent channels. The powered fan 26″ is positioned adjacent to the outlet 20″ for pushing the outside air through the outlet. Although the exemplary embodiment of the serpentine network 42″ illustrates three adjacent channels 44″ for passing outside air in respective opposing directions and two turns 52″ for passing the outside air in opposing directions from one adjacent channel to another, the serpentine network may include any number of adjacent channels and turns. In an exemplary embodiment of the serpentine network 42″, the inlet may include dimensions of 1″×1½″, the outlet may include dimensions of 2″×1½″, and the air duct may include dimensions of 2⅛″×½″×30″ in length. Additionally, in an exemplary embodiment of the serpentine network 42″, the air duct may be comprised of aluminum material. In an exemplary embodiment of the serpentine network 42″, the powered fan may include properties such as 10 CFM, 1698 FPM, and 5.98 IN per 100 foot.

The cooled beverage within the beverage container 12 may include ice, and the temperature of the cooled beverage increases from an initial temperature to an increased temperature when the outside air passes through the air duct and thermally engages the outside air with the outer surface 24 of the beverage container 12. By passing the outside air through the air duct 16 to thermally engage the outer surface 24 of the beverage container 12, BTU may be extracted from the ice of the cooled beverage.

In an exemplary embodiment of the portable cooling system, one of the beverage container and the air duct may be comprised of an aluminum material.

As illustrated in the exemplary embodiment of FIG. 4, upon positioning the air duct 16 along the outer surface 24 of the beverage container 12 such that an inner surface 22 of the air duct 16 contacts an outer surface 24 of the beverage container 12, an insulative jacket 66 covers the air duct 16 and the outer surface 24 of the beverage container 12 to provide thermal insulation for the air duct 16 to thermally engage the outer surface of the beverage container.

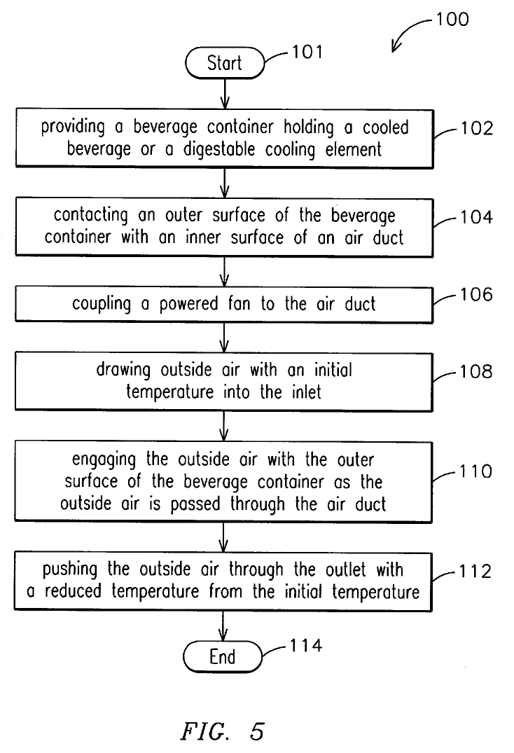

FIG. 5 illustrates an exemplary embodiment of a method 100 for portably cooling an individual. The method begins (block 101) by providing (block 102) a beverage container 12 holding a cooled beverage or a digestable cooling element. The method 100 subsequently involves contacting (block 104) an outer surface 24 of the beverage container 12 with an inner surface 22 of an air duct 16. More particularly, the method involves coupling (block 106) a powered fan 26 to the air duct, and drawing (block 108) outside air with an initial temperature into the inlet 18. The method further involves thermally engaging (block 110) the outside air with the outer surface of the beverage container 12 as the outside air is passed through the air duct 16, and pushing (block 112) the outside air through the outlet 20 with a reduced temperature from the initial temperature, before ending at 114.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed is:

1. A portable cooling system comprising:
a beverage container for holding at least one of a cooled beverage and a digestable cooling element;
an air duct including an inlet and an outlet, wherein an inner surface of at least a portion of said air duct contacts an outer surface of said beverage container; and
at least one powered fan coupled to said air duct, for drawing outside air with an initial temperature into said inlet, passing said outside air through said air duct to thermally engage said outer surface of said beverage container, and pushing said outside air through said outlet with a reduced temperature from said initial temperature.

2. The portable cooling system according to claim 1 including one powered fan coupled to said air duct,
wherein said beverage container comprises a top opening for covering with a removable top, said beverage further comprising a base, and a side portion;
and wherein said inner surface of at least a portion of said air duct includes an inner surface of said air duct between said inlet and said outlet contacting an outer surface of the side portion of said beverage container.

3. The portable cooling system according to claim 2 wherein said outlet contacts said outer surface of said side portion of the beverage container adjacent said top opening.

4. The portable cooling system according to claim 3 wherein said powered fan is positioned adjacent said outlet for pushing said outside air through at least one slit in the air duct adjacent said outlet.

5. The portable cooling system according to claim 4 wherein said powered fan is powered by at least one portable power source coupled to said outer surface of said beverage container.

6. The portable cooling system according to claim 3 wherein said inlet contacts said outer surface of said side portion of the beverage container adjacent said base.

7. The portable cooling system according to claim 6 wherein said inlet is for draining condensation collected in said air duct adjacent said base during operation of said portable cooling system.

8. The portable cooling system according to claim 2 wherein said air duct between said inlet and said outlet contacting said outer surface of said beverage container comprises a serpentine network including:
a plurality of channels extending at least a portion of the circumference of said outer surface of said beverage container, said plurality of channels adjacently positioned from said inlet to said outlet; and
a plurality of turns for passing said outside air from said inlet between adjacent channels of said plurality of channels to said outlet.

9. The portable cooling system according to claim 1 wherein said at least one of a cooled beverage and a digestable cooling element comprises ice, and wherein the temperature of said at least one of a cooled beverage and a digestable cooling element increases from an initial temperature to an increased temperature upon said passing the outside air through said air duct and thermally engaging the outside air with said outer surface of said beverage container.

10. The portable cooling system according to claim 1 wherein one of said beverage container and said air duct are comprised of an aluminum material.

11. The portable cooling system according to claim 5 further comprising a switch coupled to said portable power source for selectively turning the portable cooling system on and off.

12. The portable cooling system according to claim 1 wherein further comprising an insulative jacket for covering said air duct and said outer surface of said beverage container for providing thermal insulation for said air duct to thermally engage said outer surface of said beverage container.

13. A portable cooling system comprising:
a cooling element comprising one of a cooled beverage and ice;
a beverage container having a receptacle, wherein the cooling element is positioned within the receptacle;
an air duct including an inlet and an outlet, wherein the inlet and outlet are separated by at least one of a serpentine network and a nearly linear configured network, wherein an inner surface of at least a portion of said at least one of a serpentine network and a nearly linear configured network contacts an outer surface of said beverage container; and
at least one powered fan coupled to said air duct, for drawing outside air with an initial temperature into said inlet, passing said outside air through said at least one of a serpentine network and a nearly linear configured network to thermally engage said outer surface of said beverage container, and pushing said outside air through said outlet with a reduced temperature from said initial temperature.

14. A method for portably cooling an individual, comprising:
providing a beverage container holding at least one of a cooled beverage and a digestable cooling element;
contacting an outer surface of said beverage container with an inner surface of at least a portion of an air duct, said air duct including an inlet and an outlet;
coupling at least one powered fan to said air duct;
drawing outside air with an initial temperature into said inlet;
thermally engaging said outside air with said outer surface of said beverage container as said outside air is passed through said air duct; and
pushing said outside air through said outlet with a reduced temperature from said initial temperature.

15. The method for portably cooling an individual according to claim 14 including one powered fan coupled to said air duct, further comprising:
covering a top opening of said beverage container with a removable top, said beverage container further comprising a base, and a side portion;
and wherein said inner surface of at least a portion of said air duct includes an inner surface of said air duct between said inlet and said outlet contacting an outer surface of the side portion of said beverage container.

16. The method for portably cooling an individual according to claim 15 wherein said air duct between said inlet and said outlet contacting said outer surface of said beverage container comprises a serpentine network including:
a plurality of channels extending at least a portion of the circumference of said outer surface of said beverage container, said plurality of channels adjacently positioned from said inlet to said outlet; and
a plurality of turns for passing said outside air from said inlet between adjacent channels of said plurality of channels to said outlet.
